(19) United States
(12) Patent Application Publication
(10) Pub. No.: US 2015/0013297 A1
(43) Pub. Date: Jan. 15, 2015

(54) APPARATUS FOR SUPPORTING AND OR DIRECTING CROP IN A HARVESTING MACHINE

(71) Applicants: JOSHUA D. BACON, Johnston, IA (US); Rainer Schaefer, Zweibruecken (DE); Patrick McLawhorn, Zweibruecken (DE)

(72) Inventors: JOSHUA D. BACON, Johnston, IA (US); Rainer Schaefer, Zweibruecken (DE); Patrick McLawhorn, Zweibruecken (DE)

(21) Appl. No.: 14/310,112

(22) Filed: Jun. 20, 2014

(30) Foreign Application Priority Data
Jun. 21, 2013 (DE) 102013211829.5

(51) Int. Cl. A01D 43/08

(52) U.S. Cl. CPC A01D 43/08
USPC 56/16.4 A

(57) ABSTRACT

An apparatus for supporting and or directing crop in a harvesting machine. The apparatus includes a one-part body with an axially extending recess in which a complementary hard material insert having an edge is or can be inserted. The recess contacts the hard material insert on at least three surfaces.

### FIELD OF THE DISCLOSURE

The present disclosure generally relates to an apparatus for supporting and/or directing crop in a harvesting machine. More particularly the disclosure relates to a shear bar or a stripper, comprising a one-part body with an axially extending recess in which a complementary hard material insert comprising an edge is or can be inserted.

### BACKGROUND OF THE DISCLOSURE

Forage harvesters are agricultural harvesting machines that pick up crop from a field, chop it and transfer it to a transport vehicle via an ejection pipe. The crop can consist of plants such as corn or grain still standing on the field, or of already cut plants gathered into a swath, particularly grass, and is generally used as animal feed or for generating biogas. The cutting process takes place by means of a rotating chopper drum with a plurality of cutters distributed about its circumference, which cut the crop in cooperation with a shear bar.

The shear bar is subject to considerable wear in operation due to entrained sand particles in the crop, among other things, which is why the shear bar is typically provided with a wear-resistant coating, at least in the area of the longitudinal side serving as a cutting edge (cf. EP 1 264 535 A1). The service life of the materials that can be used for such a coating, and thus also the service life of the shear bar, is limited.

Shear bars with beveled corners have also been described, in which hard material inserts of tool steel are mounted by arc welding (cf. the prior art mentioned in EP 1 264 535 A1). In this regard, a sufficiently durable fixation of the hard material inserts, which must withstand the tangential cutting forces of the chopper drum, has proved to be problematic.

It has also been proposed to form an axial recess in the body of the shear bar, into which a mounting is bolted, which in turn has an axial groove into which are inserted wear-resistant inserts made of sintered hard metal that form the shear bar edge (see EP 0 761 089 A1). The hard material inserts are wedge-shaped with thicker ends at a distance from the shear bar edge and are fixed on the body of the shear bar by the bolts and the mount. This fixation of the hard material inserts is relatively expensive to produce due to the selected wedge shape of the hard material inserts and the mounting, and also requires that the bolts are always tight enough to keep the hard material inserts at their intended position.

Similar wear problems also exist for strippers, which are associated in forage harvesters with rollers in the intake duct or with post-cut devices. Strippers are also used in other harvesting machines, however, such as combines or balers.

The problem addressed by the invention is considered to be that of providing an apparatus for supporting and/or directing crop in a harvesting machine that does not have the above-mentioned disadvantages or has them to a reduced extent.

### SUMMARY OF THE DISCLOSURE

An apparatus for supporting and/or directing crop in a harvesting machine, particularly a shear bar for a forage harvester or a stripper, is composed of a one-part body with an axially extending recess and at least one complementary hard material insert, having an edge, and fitting into the recess. At least one surface of the recess is arranged such that a torque acting during operation on the hard material insert is transmitted by the hard material insert onto the body.

In this manner, the hard material insert is fixed and braced against the cutting forces (acting in the tangential direction of the cutters cooperating with the shear bar) and the torques induced by the cutting forces, (i.e. in the tangential and radial direction of the cutters for the chopper drum). The hard material insert in a stripper is analogously secured against the torque induced by the shearing force of the crop. An undesired movement of the hard material insert relative to the body need not be feared. The result is that the service life of the apparatus is extended.

The separate mounting that was still provided in the prior art according to EP 0 761 089 A1 is superfluous due to the one-part construction of the body.

In particular, the surface can enclose the hard material insert between said surface and a further surface of the body.

In one possible embodiment, the recess contacts at least three surfaces of the hard material insert in the mounted state. Alternatively, the hard material insert can have a protrusion with a triangular cross section.

In particular, the hard material insert and the body are or can be fixed to one another by an additional axially extending depression arranged in the recess and a protrusion that engages with it. The depression is preferably arranged in the body, while the protrusion is arranged on the hard material insert. A reverse attachment can also be conceived, however. Any other shapes of the depression such as a semicircular cross section, which additionally can comprise a flat surface, can also be conceived. In the concept of the present invention, the semicircular cross section implements a virtually infinite number of surfaces at which the hard material insert and the body contact one another.

The depression and the protrusion preferably have an at least approximately rectangular cross section, although triangular and any other cross sections are possible.

In addition, the depression and the protrusion extend parallel to the upper side of the body or at an angle of 45° downward therefrom. The cutting or shearing forces then press the protrusion into the recess (or vice versa) and interlock the hard material insert in the body. The resistance to the tangential cutting forces is further increased by an upward-directed angular shape of the depression and the protrusion. It goes without saying that angles other than 45° are also possible.

In one possible embodiment, a plurality of hard material inserts are arranged one after another in the axial direction and have complementary end sections engaging with one another. The edge is therefore composed of a plurality of segments arranged one after another in the axial direction, which are fixed to one another relative to the chopper drum or roller by the end sections in a tangential and/or radial direction (i.e. in the radial plane of the chopper drum or roller) and in the axial direction, in order to avoid undesired shifting or other movements of the hard material inserts relative to the body.

The hard material insert can additionally form a non-axial edge, which can be sawtooth-shaped or corrugated, inclined or equipped with depressions (cf. EP 0 022 053 A1). Because the chopper drum interacting with the shear bar is cylindrical in design, as in the prior art, the edge in this embodiment must follow the cylinder three-dimensionally in order to achieve a constant cutting gap over the length of the shear bar. Because the shear bar is not arranged axially, but at an angle to the axial line, the cutting process is free from distortion with an unchanged cylindrical chopper drum geometry because larger cutting angles become possible, which has a positive effect on the cutting forces and the service life as well as the noise emission. The cutting frequency and the noise spectrum that arise can even be modified and optimized by the different angles of the shear bar across the width of the chopper drum. In addition, the problem of conveying the chopping material axially toward the center of the drum, which was observed in the prior art with straight shear bars and cutters on the chopper drum arranged at an angle, can be avoided or reduced if the inclination of the slanted sections of the shear bar is oriented to the outside.

The hard material insert consists in particular of sintered or cast hard metal. The hard material inserts with a non-axial edge described in the previous paragraph can also be produced without problems with this manufacturing method.

Other features and aspects will become apparent by consideration of the detailed description and accompanying drawings.

### BRIEF DESCRIPTION OF THE DRAWINGS

FIG. 1 shows a forage harvester in a side view and in a schematic representation.

FIG. 2 shows a cross section through a first embodiment of a shear bar.

FIG. 3 shows a cross section through a second embodiment of a shear bar.

FIG. 4 shows a cross section through a third embodiment of a shear bar.

FIG. 5 shows a cross section through a fourth embodiment of a shear bar.

FIG. 6 shows a cross section through a fifth embodiment of a shear bar.

FIG. 7 shows a cross section through a sixth embodiment of a shear bar.

FIG. 8 shows a cross section through a seventh embodiment of a shear bar.

FIG. 9 shows a cross section through an eighth embodiment of a shear bar.

FIG. 10 shows a front view of a ninth embodiment of a shear bar.

FIG. 11 shows a front view of a tenth embodiment of a shear bar.

FIG. 12 shows a side view of a roller with a stripper for a post-cut device.

FIG. 13 shows a side view of a chopper drum with a shear bar and strippers.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION OF THE DRAWINGS

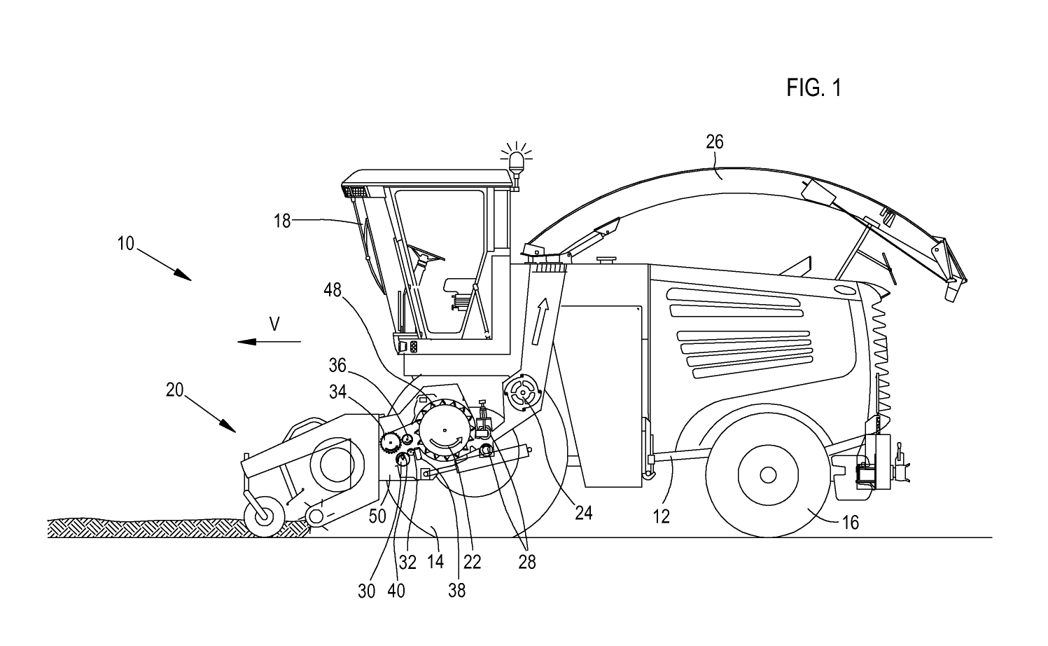

FIG. 1 illustrates a forage harvester 10 that is self-propelled. The forage harvester 10 is constructed on a frame 12, which is carried by front and rear wheels 14 and 16. The forage harvester 10 is operated from a driver's cab 18, from which a crop receiving device 20 in the form of a pickup can be seen. Material picked up from the ground by means of the crop receiving device 20, e.g. grass or the like, is fed to a chopping unit that is constructed here from a chopping drum 22 equipped with a plurality of cutters 48, which chops the material into small pieces in cooperation with a shear bar 38 and supplies it to a conveyor device 24. In other forage harvesters, particularly attached or towed forage harvesters, the chopping unit can consist of a disk chopper instead of the chopping drum 22. The material leaves the forage harvester 10 for a trailer traveling alongside via a discharge chute 26 that is height adjustable and rotatable about the vertical axis. A post-cut device with two rollers 28, through which the material to be conveyed is supplied tangentially to the conveyor device 24, is located between the chopping drum 22 and the conveyor device 24.

Between the crop receiving device 20 and the chopping drum 22, the material is transported by an intake conveyor with lower intake rollers 30, 32 and upper intake rollers 34, 36, which are mounted inside an intake housing 50. The lower intake rollers 30, 32 and the upper intake rollers 34, 36 are also referred to as pre-pressing rollers, because the upper intake rollers 34, 36 are pre-tensioned against the lower intake rollers 30, 32 by hydraulic and/or spring force, so that the crop is pre-compressed between the lower intake rollers 30, 32 and the upper intake rollers 34, 36 and can be cut better. Directional indications such as front and back refer below to the forward direction V of the forage harvester 10, which runs from right to left in FIG. 1.

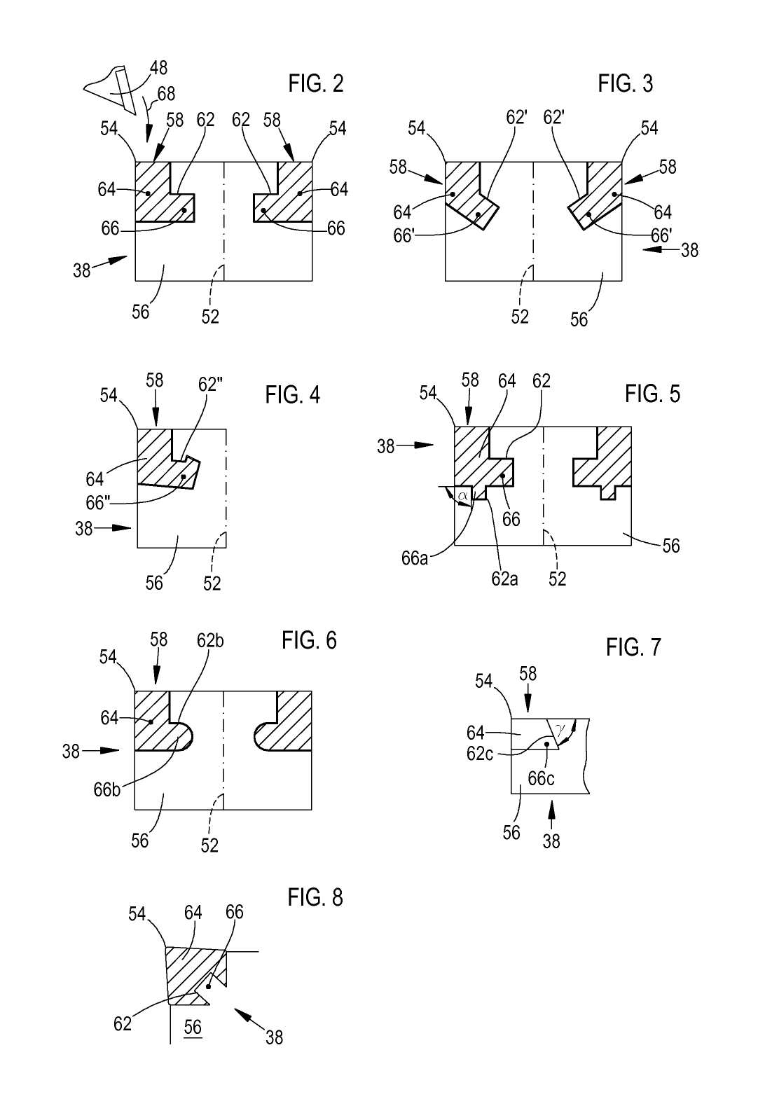

FIG. 2 shows a first embodiment of the shear bar 38 according to the disclosure for the forage harvester 10 of FIG. 1. The shear bar 38 is designed symmetrically, relative to a longitudinal center plane 52, so that after the end of the service life of an edge 54, the insert can be rotated by 180 degrees and continue to be used. Alternatively, the hard material layer can be applied only on one side, which makes rotating a shear bar 38 after it has become worn impossible. The shear bar 38 comprises a one-part body 56, at the upper corners of which are arranged two recesses 58 that are axially extending and relatively large and have a rectangular cross section. On each side of the recesses 58 facing the longitudinal center plane 52, are smaller depressions 62 extending axially in the one-part body 56, which likewise have a rectangular cross section, are formed at the lower end of the recesses 58 as drawn, i.e. a distance away from the upper side of the shear bar 38.

One hard material insert 64 that is complementary-fitting and axially extending is arranged in each of the recesses 58 and comprises a protrusion 66 that is axially extending and rectangular and extends into the depression 62. The cross section of the recesses 58 with the depressions 62 is accordingly L-shaped, which also applies to the cross section of the hard material insert 64 with the protrusion 66. The hard material insert 64 is fixed to the one-part body 56, for example screwed on, glued and/or welded at the upper transitions. The faces of the hard material insert 64 and the one-part body 56 that face one another need not be flat as shown in FIG. 2, but can also be corrugated, sawtooth-shaped, step-shaped or profiled in the manner of a dovetail. The profiling can extend in the radial plane of the chopping drum 22, or in an axial direction or at any desired angle diagonally thereto.

The hard material insert 64 with the protrusion 66 drawn on the right side is enclosed on four surfaces by the surrounding recess 58 with the depressions 62, namely from below on the underside, from the right at the surfaces of the actual hard material insert 64 and the protrusion 66 from the right (i.e. in the radial direction of the chopping drum 22), and from the top at the upper side of the protrusion 66 (i.e. in the tangential direction of the chopping drum 22).

If the hard material insert 64 drawn on the left in FIG. 2 cooperates with the cutters 48 of the chopping drum 22, the cutters 48 move in the direction of the arrow 68 and cut the crop in cooperation with the edge 54. In the process, cutting forces directed downward arise, which press the hard material insert 64 downward against the one-part body 56. The cutting forces also produce a torque in the counterclockwise direction in the hard material insert 64, which presses the protrusion 66 of the hard material insert 64 into the depressions 62 and presses the upper wall and the right-hand wall of the protrusion 66 against the lower wall and the vertical wall of the depressions 62. The torque arising while cutting the crop is accordingly deviated via the protrusion 66 and the depressions 62 into the one-part body 56, so that the mechanical connection between the hard material insert 64 and the one-part body 56 is relieved and a detachment of the hard material insert 64 from the one-part body 56 need not be feared.

In the second embodiment, as seen in FIG. 3, the depressions 62′ and the protrusion 66′ are rotated downward by 45 degrees relative to the first embodiment according to FIG. 2. In the third embodiment, as seen in FIG. 4, the depressions 62″ and the protrusion 66″ are each angularly shaped and form a hook that angles upward. The function or operation correspond to those of the embodiment according to FIG. 2 because the hard material insert 64 is likewise surrounded on at least three sides (by four in the embodiment according to FIG. 3 and even by six in the embodiment according to FIG. 4) by the surrounding recesses 58 with the depressions 62. In the embodiment according to FIG. 4, the hard material insert 64 is pushed in the axial direction into the recesses 58 and the depressions 62″, because (differently from the embodiments according to FIGS. 2, 3 and 8) they cannot be pushed horizontally due to the shapes of the depressions 62″ and the protrusion 66″.

In order to absorb the forces arising opposite to the cutting direction, which can appear for example during a displacement of the shear bar 38 based on a contact, the one-part body 56 and the hard material insert 64 can be provided according to FIG. 5 with an additional protrusion 66a that extends downward, which penetrates into an associated depression 62a in the one-part body 56. This protrusion 66a can deviate from the horizontal by an angle a that is not necessarily a right angle. In addition, the protrusion 66a can be formed in an L shape analogously to the embodiment according to FIG. 4, wherein the hook can extend to the left or the right.

In the embodiment according to FIG. 6, the protrusion 66b and the depression 62b are provided with semicircular-shaped cross sections. This semicircular shape provides a virtually infinite number of surfaces at which the one-part body 56 and the hard material insert 64 can contact one another, and secures the hard material insert 64 against the torques occurring while cutting.

FIG. 7 shows an embodiment in which the depression 62c has a triangular cross section. The cross section of the protrusion 66c fitting into the depression 62c is analogously triangular. Thus there are two surfaces at which the hard material insert 64 makes contact in the one-part body 56. The angle y of the depression 62c ensures that the torques occurring while cutting are transmitted by the hard material insert 64 onto the one-part body 56, because the resulting inclined surface transmits the torque from the hard material insert 64 to the one-part body 56.

In the embodiment according to FIG. 8, the depression 62 (arranged inside the recess 58) is provided in the hard material insert 64 while the protrusion 66 is a component of the one-part body 56. The angles and the mode of operation of the depression 62 and the protrusion 66 correspond to the embodiment according to

FIG. 3.

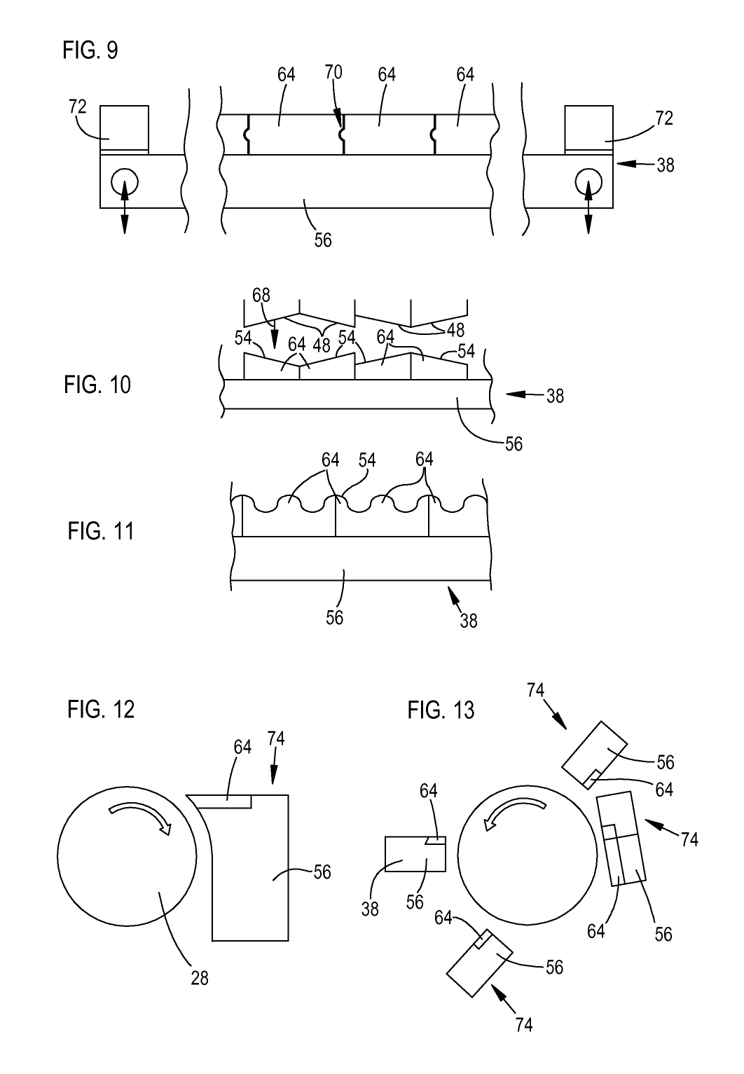

The plan view of the shear bar 38 shown in FIG. 9 shows that a number of hard material inserts 64 follow one after another in the axial direction of the shear bar 38. The hard material inserts 64 can correspond to one of the embodiments according to the other figures. The end sections 70 of the hard material inserts 64 are interlocked with one another, i.e. one end section 70 has a depression with which a protrusion of an adjacent end section 70 engages. The end sections 70 can also be profiled in any other desired manner, e.g. corrugated, sawtooth-shaped or dovetail-shaped. Thereby the hard material inserts 64 are fixed to one another in the radial direction of the chopping drum 22. The step-like (or corrugated, sawtooth-shaped or dovetail-shaped) interlocking of the end sections 70 shown in FIG. 9 could be additionally or alternatively arranged in the vertical direction, in order to fix the hard material inserts 64 to one another in the tangential direction of the chopping drum 22. The one-part body 56 is coupled at both ends to the frame 12 of the forage harvester 10 by adjusting devices (not shown), with which the cutting gap between the cutters 48 and the edge 54 can be adjusted to a desired dimension. Brackets 72 for axial fixation of the hard material inserts 64 can be attached there. The connection in the shear bar 38 is fundamentally based on form-fitting engagement; axial securing is achieved by means of frictional engagement.

FIG. 10 shows a front view of one possible embodiment of the shear bar 38. The edges 54 of the hard material inserts 64 are not oriented axially, (i.e. parallel to the axis of rotation of the chopping drum 22), but rather at an angle thereto. In the illustrated embodiment, each hard material insert 64 has an edge 54 for cutting that is straight over its entire axial length. It would also be possible, however, to design the angle of the edge 54 so as to vary across the length of the hard material insert 64 (e.g., by integrating two adjacent hard material inserts 64 of FIG. 10 into a single hard material insert 64).

The edges 54 form a sawtooth shape in the embodiment according to FIG. 10. The cutters 48 of the chopping drum 22, which move in the direction of the arrow 68, are preferably angled in the opposite direction, as likewise shown in FIG. 10. This increases the cutting angle at which the crop is cut between the cutting edges of the cutters 48 and the edges 54. A noise reduction can be achieved with the illustrated, irregular arrangement of the angles. The edges 54 can also be arranged so as to decline toward the outside from the central longitudinal plane of the shear bar, in order to push the crop to the outside and reduce the increased accumulation of crop in the machine center that has been observed in the prior art.

In the embodiment according to FIG. 11, the edges 54 are formed with a three-dimensional corrugated shape. The cutters used here (not shown) can have axial cutting edges or angled cutting edges analogous to FIG. 10.

For the non-axially oriented edges 54 of FIGS. 10 and 11, it must be taken into account that the cutters 48 of the chopping drum 22 describe a cylindrical envelope circle that the edges 54 must follow with the narrowest possible gap in order to enable an energy-saving cutting process. Therefore, the hard material inserts 64 should be designed as three-dimensional structures with three-dimensionally curved edges 54 in order to produce the desired cutting. The hard material inserts 64 can be produced for this purpose especially by sintering or casting. Non-cylindrical shapes of the chopping drum 22 can also be conceived, to which the shape of the hard material inserts 64 must then be adapted; in this regard, the reader is referred to the disclosure in DE 10 2012 201 334 A1.

The present invention is not only for use with shear bars 38, but also for strippers 74 that can be associated with the rollers 28 of the post-cut device (cf. FIG. 12) or the chopping drum 22 (cf. FIG. 13) or one or more of the lower intake rollers 30, 32 and upper intake rollers 34, 36. The stripper 74 can also be used on a roller of a baler or a conveyor drum of a combine harvester. The stripper 74 can be mounted with any desired orientation, as is schematically shown in FIG. 13. However, the stripper 74 is positioned, unlike that which is shown in FIG. 13, at the outlet to the duct for the post-cut device.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Various features are set forth in the following claims.

What is claimed is:

1. An apparatus for supporting or directing crop in a harvesting machine, the apparatus comprising:
a one-part body comprising an axially extending recess; and
a hard material insert comprising an edge that is received by the axially extending recess;
wherein a surface of the axially extending recess is operable to transmit a torque from the hard material insert to the one-part body.

2. The apparatus of claim 1, wherein the surface retains the hard material insert between the surface and an additional surface of the one-part body.

3. The apparatus of claim 1, wherein the hard material insert comprises a triangular cross section that is contacted by the axially extending recess on all sides in a mounted state.

4. The apparatus of claim 1, wherein the hard material insert comprises a protrusion and the one-part body comprises a depression arranged in the axially extending recess that receives the protrusion.

5. The apparatus of claim 4, wherein the depression and the protrusion have a cross section that is one of substantially rectangular, round, and triangular.

6. The apparatus of claim 4 wherein the depression and the protrusion extend parallel to at least one of an upper side of the one-part body and a downward therefrom.

7. The apparatus of claim 4, wherein the depression and the protrusion are angular and are directed upward or downward.

8. The apparatus of claim 1, wherein the hard material insert extends over the entire length of the apparatus.

9. The apparatus of claim 1, wherein a plurality of hard material inserts are arranged one following another in an axial direction and have complementary end sections that engage with one another.

10. The apparatus according to claim 1, wherein the hard material insert forms a non-axial edge.

11. The apparatus according to claim 7, wherein the hard material insert forms a sawtooth-shaped or corrugated edge.

12. The apparatus according to claim 1, wherein the hard material insert consists of at least one of sintered and cast hard metal.

13. The apparatus of claim 1, wherein the apparatus is a shear bar.

14. The apparatus of claim 1, wherein the apparatus is a stripper.

15. A harvesting machine comprising:
a chopping drum; and
an apparatus in communication with the chopping drum for supporting or directing crop in the harvesting machine, the apparatus comprising:
a one-part body comprising an axially extending recess; and
a hard material insert comprising an edge that is received by the axially extending recess;
wherein a surface of the axially extending recess is operable to transmit a torque from the hard material insert to the one-part body.

16. The harvesting machine of claim 15, wherein the surface retains the hard material insert between the surface and an additional surface of the one-part body.

17. The harvesting machine of claim 15, wherein the hard material insert comprises a triangular cross section that is contacted by the axially extending recess on all sides in a mounted state.

18. A shear bar of a harvesting machine, the shear bar comprising:
a one-part body comprising an axially extending recess; and
a hard material insert comprising an edge that is received by the axially extending recess;
wherein a surface of the axially extending recess is operable to transmit a torque from the hard material insert to the one-part body.

19. The shear bar of claim 18, wherein the surface retains the hard material insert between the surface and an additional surface of the one-part body.

20. The shear bar of claim 18, wherein the hard material insert comprises a triangular cross section that is contacted by the axially extending recess on all sides in a mounted state.
